(19) United States
(12) Patent Application Publication
(10) Pub. No.: US 2026/0188953 A1
(43) Pub. Date: Jul. 2, 2026

(54) Conductive Component Assembly and Receiving End Conductive Component and Mating End Conductive Component Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/433,432

(22) Filed: Dec. 26, 2025

(30) Foreign Application Priority Data
Dec. 27, 2024 (TW) 113214401

(51) Int. Cl. H01R 13/64; H01R 12/70; H01R 12/72; H01R 13/24; H01R 13/50

(52) U.S. Cl. CPC H01R 13/64; H01R 12/7082; H01R 12/724; H01R 12/727; H01R 13/24; H01R 13/50

(57) ABSTRACT

A conductive component assembly and receiving end conductive component and mating end conductive component thereof, wherein the receiving end conductive component comprises a receiving end conductive component insulation core mating recess, and the mating end conductive component comprises a mating end conductive component insulation core mating head. The mating end conductive component insulation core mating head is configured to align with the receiving end conductive component insulation core mating recess, thereby entering the receiving end conductive component insulation core mating recess, such that during use, the mating end conductive component and the receiving end conductive component can be in a proper mating condition, allowing the conductive component assembly to accommodate the reduced size of electronic devices while maintaining the expected electrical characteristics, and thus meeting the specific requirements and developments of electronic devices.

### CROSS-REFERENCE TO RELATED APPLICATIONS

This application claims the priority of Republic of China Patent Application No. 113214401 filed on Dec. 27, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly to a small-sized conductive component assembly and receiving end conductive component and mating end conductive component thereof.

### Descriptions of the Related Art

With the trend of electronic devices becoming thinner and more compact, a conductive component assembly, as one of the critical components inside an electronic device, has also been evolving towards miniaturization, resulting in increasingly smaller dimensions of the conductive component assembly. In general, the conductive component assembly comprises a receiving end conductive component and a mating end conductive component, wherein the mating end conductive component is configured to mate with the receiving end conductive component to transmit signals within the electronic device.

However, the smaller the conductive component assembly is, the more difficult it is for the mating end conductive component to mate with the receiving end conductive component. For example, due to the reduced size of the conductive component assembly, it becomes more difficult for the mating end conductive component to align with the receiving end conductive component. As a result, the conductive component assembly when in use often encounters a misalignment issue between the mating end conductive component and the receiving end conductive component, leading to electrical characteristics of the conductive component assembly failing to meet expected performance.

In view of the foregoing, how to resolve the issue of improper mating between components in a small-sized conductive component assembly has become a technical challenge that the industry is urgently striving to overcome.

### SUMMARY OF THE INVENTION

In view of the drawbacks of the prior art mentioned above, the present application provides a conductive component assembly, comprising: a receiving end conductive component comprising a receiving end conductive component insulation core, a receiving end conductive component upper terminal, and a receiving end conductive component lower terminal, wherein the receiving end conductive component insulation core comprises a receiving end conductive component insulation core mating recess, the receiving end conductive component upper terminal comprises a receiving end conductive component upper terminal mating structure, and the receiving end conductive component lower terminal comprises a receiving end conductive component lower terminal mating structure, wherein the receiving end conductive component insulation core is configured to be coupled with the receiving end conductive component upper terminal and the receiving end conductive component lower terminal, such that the receiving end conductive component upper terminal mating structure abuts an upper wall of the receiving end conductive component insulation core mating recess, and the receiving end conductive component lower terminal mating structure abuts a lower wall of the receiving end conductive component insulation core mating recess; and a mating end conductive component configured to mate with the receiving end conductive component, the mating end conductive component comprising a mating end conductive component insulation core, a mating end conductive component upper terminal, and a mating end conductive component lower terminal, wherein the mating end conductive component insulation core comprises a mating end conductive component insulation core mating head, the mating end conductive component upper terminal comprises a mating end conductive component upper terminal mating structure and a mating end conductive component upper terminal elastic structure, and the mating end conductive component lower terminal comprises a mating end conductive component lower terminal mating structure and a mating end conductive component lower terminal elastic structure, wherein the mating end conductive component insulation core is configured to mate with the mating end conductive component upper terminal and the mating end conductive component lower terminal, such that the mating end conductive component upper terminal mating structure is located above the mating end conductive component insulation core mating head, and the mating end conductive component lower terminal mating structure is located below the mating end conductive component insulation core mating head; wherein, when the mating end conductive component is mating with the receiving end conductive component, the mating end conductive component insulation core mating head is configured to align with the receiving end conductive component insulation core mating recess to allow the mating end conductive component insulation core mating head to enter the receiving end conductive component insulation core mating recess, wherein the mating end conductive component upper terminal elastic structure is configured to apply an elastic force to the mating end conductive component upper terminal mating structure, such that the mating end conductive component upper terminal mating structure abuts the receiving end conductive component upper terminal mating structure, thereby enabling the mating end conductive component upper terminal to mate with the receiving end conductive component upper terminal, and wherein the mating end conductive component lower terminal elastic structure is configured to apply an elastic force to the mating end conductive component lower terminal mating structure, such that the mating end conductive component lower terminal mating structure abuts the receiving end conductive component lower terminal mating structure, thereby enabling the mating end conductive component lower terminal to mate with the receiving end conductive component lower terminal.

Preferably, the conductive component assembly said above, wherein the receiving end conductive component insulation core further comprises a receiving end conductive component insulation core guiding hole, and the mating end conductive component further comprises a mating guide element, the mating guide element comprising a mating guide structure, wherein the mating end conductive component insulation core is configured to mate with the mating guide element such that the mating guide structure is extended from the mating end conductive component insulation core, and when the mating end conductive component is mating with the receiving end conductive component, the mating guide structure is configured to enter the receiving end conductive component insulation core guiding hole and thereby guide the mating end conductive component insulation core mating head into the receiving end conductive component insulation core mating recess.

Preferably, the conductive component assembly said above, wherein an extension length of the mating guide structure is greater than an extension length of the mating end conductive component insulation core mating head, such that the mating guide structure enters the receiving end conductive component insulation core guiding hole before the mating end conductive component insulation core mating head enters the receiving end conductive component insulation core mating recess.

Preferably, the conductive component assembly said above, wherein the mating guide structure is a columnar structure.

Preferably, the conductive component assembly said above, wherein the receiving end conductive component further comprises a receiving end conductive component plate; the receiving end conductive component upper terminal further comprises a receiving end conductive component upper terminal joining structure and a receiving end conductive component upper terminal connecting structure, wherein the receiving end conductive component upper terminal connecting structure comprises a receiving end conductive component upper terminal connecting structure bent extension section and is configured to connect the receiving end conductive component upper terminal mating structure and the receiving end conductive component upper terminal joining structure via the receiving end conductive component upper terminal connecting structure bent extension section that provides a bent connection, so as to allow the receiving end conductive component upper terminal joining structure to extend along a receiving end conductive component upper terminal joining path to join with the receiving end conductive component plate; and the receiving end conductive component lower terminal further comprises a receiving end conductive component lower terminal joining structure and a receiving end conductive component lower terminal connecting structure, wherein the receiving end conductive component lower terminal connecting structure comprises a receiving end conductive component lower terminal connecting structure bent extension section and is configured to connect the receiving end conductive component lower terminal mating structure and the receiving end conductive component lower terminal joining structure via the receiving end conductive component lower terminal connecting structure bent extension section that provides a bent connection, so as to allow the receiving end conductive component lower terminal joining structure to extend along a receiving end conductive component lower terminal joining path to join with the receiving end conductive component plate, wherein the receiving end conductive component upper terminal joining path and the receiving end conductive component lower terminal joining path extend substantially in parallel.

Preferably, the conductive component assembly said above, wherein the mating end conductive component further comprises a mating end conductive component plate; the mating end conductive component upper terminal further comprises a mating end conductive component upper terminal joining structure and a mating end conductive component upper terminal connecting structure, wherein the mating end conductive component upper terminal connecting structure comprises a mating end conductive component upper terminal connecting structure straight extension section and is configured to connect the mating end conductive component upper terminal mating structure and the mating end conductive component upper terminal joining structure via the mating end conductive component upper terminal connecting structure straight extension section that provides a straight connection, so as to allow the mating end conductive component upper terminal joining structure to extend along a mating end conductive component upper terminal joining path to join with the mating end conductive component plate; and the mating end conductive component lower terminal further comprises a mating end conductive component lower terminal joining structure and a mating end conductive component lower terminal connecting structure, wherein the mating end conductive component lower terminal connecting structure comprises a mating end conductive component lower terminal connecting structure straight extension section and is configured to connect the mating end conductive component lower terminal mating structure and the mating end conductive component lower terminal joining structure via the mating end conductive component lower terminal connecting structure straight extension section that provides a straight connection, so as to allow the mating end conductive component lower terminal joining structure to extend along a mating end conductive component lower terminal joining path to join with the mating end conductive component plate, wherein the mating end conductive component upper terminal joining path and the mating end conductive component lower terminal joining path extend substantially in parallel.

Preferably, the conductive component assembly said above, wherein the receiving end conductive component upper terminal joining path and the mating end conductive component upper terminal joining path extend substantially orthogonally; and the receiving end conductive component lower terminal joining path and the mating end conductive component lower terminal joining path extend substantially orthogonally.

Preferably, the conductive component assembly said above, wherein the mating end conductive component insulation core mating head comprises a mating end conductive component upper terminal receiving space and a mating end conductive component lower terminal receiving space, and when the mating end conductive component is mating with the receiving end conductive component, at least a portion of the mating end conductive component upper terminal is configured to be received in the mating end conductive component upper terminal receiving space, and at least a portion of the mating end conductive component lower terminal is configured to be received in the mating end conductive component lower terminal receiving space.

Preferably, the conductive component assembly said above, wherein an upper recess wall of the receiving end conductive component insulation core mating recess is configured to support the receiving end conductive component upper terminal mating structure, such that the receiving end conductive component upper terminal mating structure is configured to elastically deform the mating end conductive component upper terminal, thereby allowing at least a portion of the mating end conductive component upper terminal to be received in the mating end conductive component upper terminal receiving space; and a lower recess wall of the receiving end conductive component insulation core mating recess is configured to support the receiving end conductive component lower terminal mating structure, such that the receiving end conductive component lower terminal mating structure is configured to elastically deform the mating end conductive component lower terminal, thereby allowing at least a portion of the mating end conductive component lower terminal to be received in the mating end conductive component lower terminal receiving space.

Additionally, the present application provides a receiving end conductive component comprising: a receiving end conductive component insulation core comprising a receiving end conductive component insulation core mating recess; a receiving end conductive component upper terminal comprising a receiving end conductive component upper terminal mating structure; and a receiving end conductive component lower terminal comprising a receiving end conductive component lower terminal mating structure, wherein the receiving end conductive component insulation core is configured to mate with the receiving end conductive component upper terminal and the receiving end conductive component lower terminal, such that the receiving end conductive component upper terminal mating structure abuts and is supported by an upper recess wall of the receiving end conductive component insulation core mating recessto be configured for mating, and the receiving end conductive component lower terminal mating structure abuts and is supported by a lower recess wall of the receiving end conductive component insulation core mating recessto be configured for mating.

Additionally, the present application provides a mating end conductive component comprising: a mating end conductive component insulation core comprising a mating end conductive component insulation core mating head; a mating end conductive component upper terminal comprising a mating end conductive component upper terminal mating structure and a mating end conductive component upper terminal elastic structure; and a mating end conductive component lower terminal comprising a mating end conductive component lower terminal mating structure and a mating end conductive component lower terminal elastic structure, wherein the mating end conductive component insulation core is configured to mate with the mating end conductive component upper terminal and the mating end conductive component lower terminal such that the mating end conductive component upper terminal mating structure is located above the mating end conductive component insulation core mating head, and the mating end conductive component lower terminal mating structure is located below the mating end conductive component insulation core mating head; and the mating end conductive component upper terminal elastic structure is configured to apply an elastic force to the mating end conductive component upper terminal mating structure to allow the mating end conductive component upper terminal mating structure to be configured for mating; and the mating end conductive component lower terminal elastic structure is configured to apply an elastic force to the mating end conductive component lower terminal mating structure to allow the mating end conductive component lower terminal mating structure to be configured for mating.

Compared with the prior art, the present application provides a conductive component assembly and receiving end conductive component and mating end conductive component thereof. The receiving end conductive component comprises a receiving end conductive component insulation core mating recess, and the mating end conductive component comprises a mating end conductive component insulation core mating head. The mating end conductive component insulation core mating head is configured to align with the receiving end conductive component insulation core mating recess, thereby allowing the mating end conductive component insulation core mating head to easily enter the receiving end conductive component insulation core mating recess. In addition, the conductive terminals of the mating end conductive component are configured to elastically mate with the conductive terminals of the receiving end conductive component. In this way, the issue of improper mating of components in a small-sized conductive component assembly can be resolved, such that during use, the mating end conductive component and the receiving end conductive component can be properly mated, allowing the conductive component assembly to accommodate the reduced size of electronic devices while maintaining the expected electrical characteristics, and thus meeting the specific requirements and developments of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the conductive component assembly of the present application in an embodiment.

FIG. 2 is a perspective schematic view of the conductive component assembly of the present application from a first viewing angle in an embodiment.

FIG. 3 is a perspective schematic view of the conductive component assembly of the present application from a second viewing angle in an embodiment.

FIG. 4 is a top schematic view of the conductive component assembly of the present application in an embodiment.

FIG. 5 is a sectional schematic view of a portion of the conductive component assembly shown in FIG. 4, taken along line AA.

FIG. 6 is a sectional schematic view of a portion of the conductive component assembly shown in FIG. 4, taken along line BB.

FIG. 7 is a sectional schematic view of a portion of the conductive component assembly shown in FIG. 4, taken along line CC.

FIG. 8 is a perspective schematic view of the conductive component assembly of the present application in an embodiment.

FIG. 9 is a perspective schematic view of the conductive component assembly of the present application from a first viewing angle in an embodiment.

FIG. 10 is a perspective schematic view of the conductive component assembly of the present application from a second viewing angle in an embodiment.

FIG. 11 is a top schematic view of the conductive component assembly of the present application in an embodiment.

FIG. 12 is a sectional schematic view of a portion of the conductive component assembly shown in FIG. 11, taken along line DD.

FIG. 13 is a sectional schematic view of a portion of the conductive component assembly shown in FIG. 11, taken along line EE.

FIG. 14 is a sectional schematic view of a portion of the conductive component assembly shown in FIG. 11, taken along line FF.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

It should also be noted that, for the sake of clarity and conciseness of the disclosure, components having the same or similar functions in the following embodiments will be described using the same reference numerals, and descriptions of identical or equivalent features will be omitted.

The present application provides a conductive component assembly and receiving end conductive component and mating end conductive component thereof. The receiving end conductive component comprises a receiving end conductive component insulation core mating recess, and the mating end conductive component comprises a mating end conductive component insulation core mating head. The mating end conductive component insulation core mating head is aligned with the receiving end conductive component insulation core mating recess, thereby entering the receiving end conductive component insulation core mating recess, such that during use, the mating end conductive component and the receiving end conductive component can be properly mated, allowing the conductive component assembly to accommodate the reduced size of electronic devices while maintaining the expected electrical characteristics, thus meeting the specific requirements and developments of electronic devices.

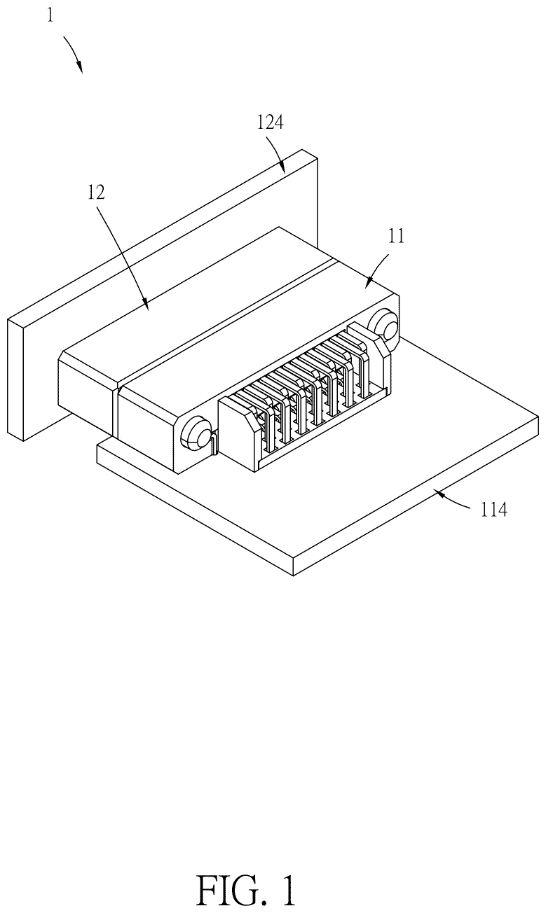

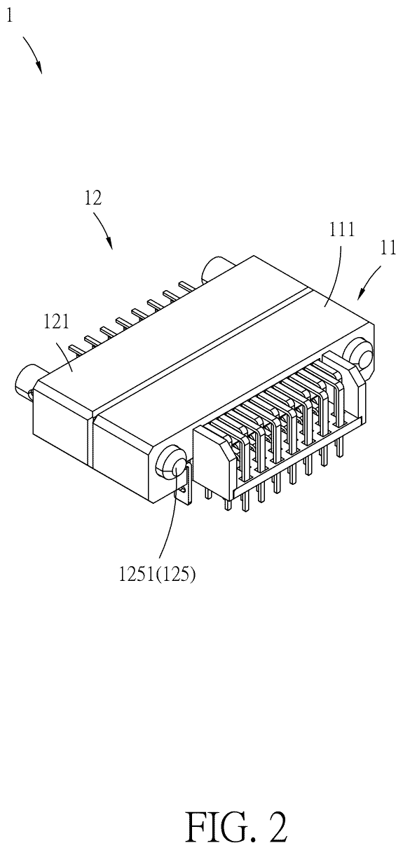

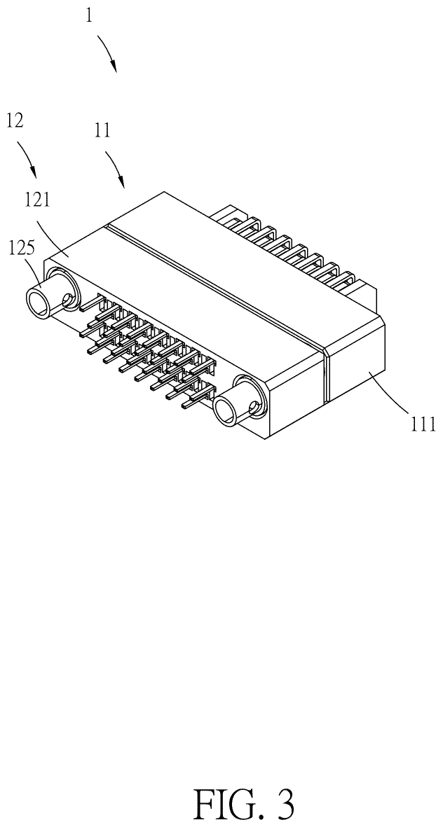

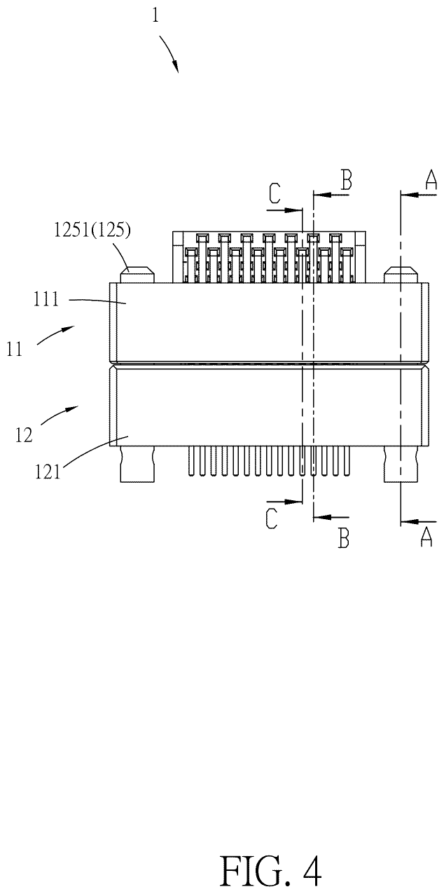

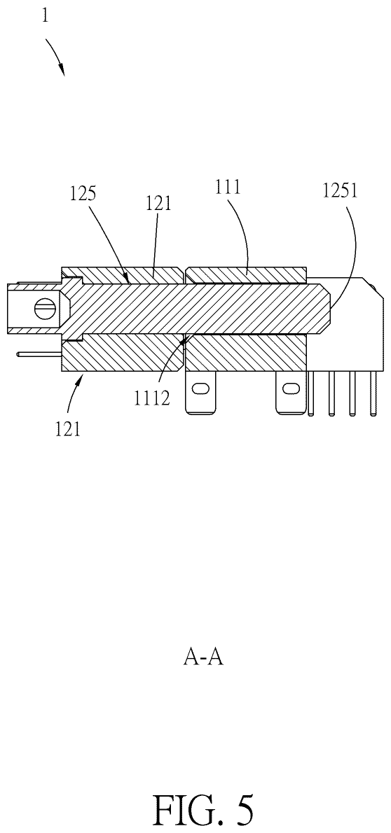

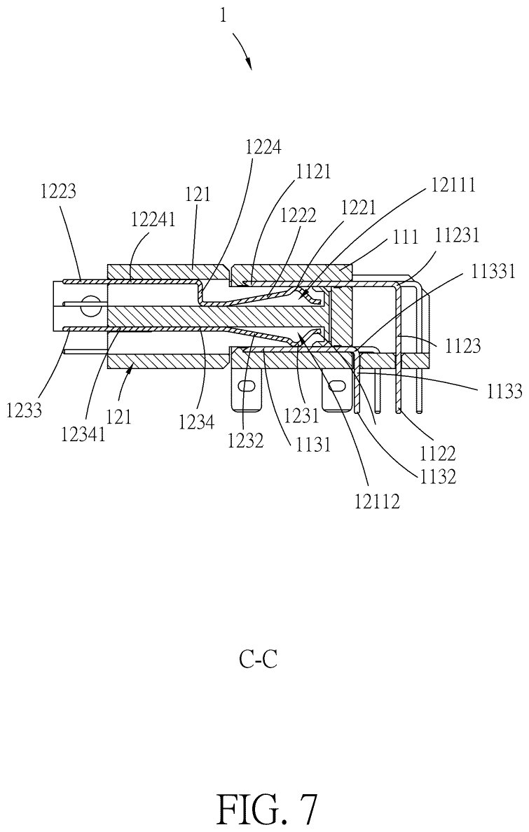

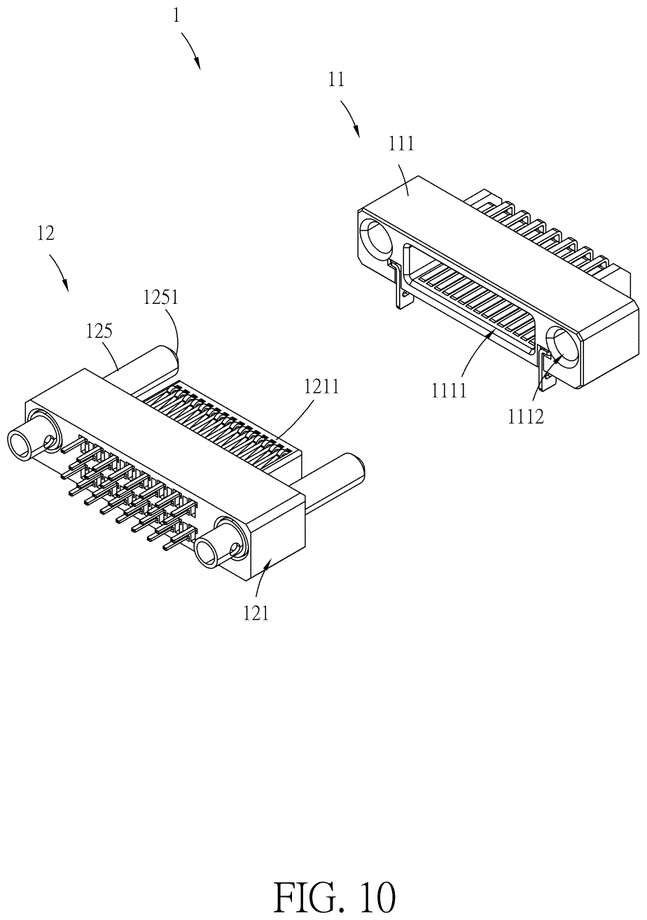

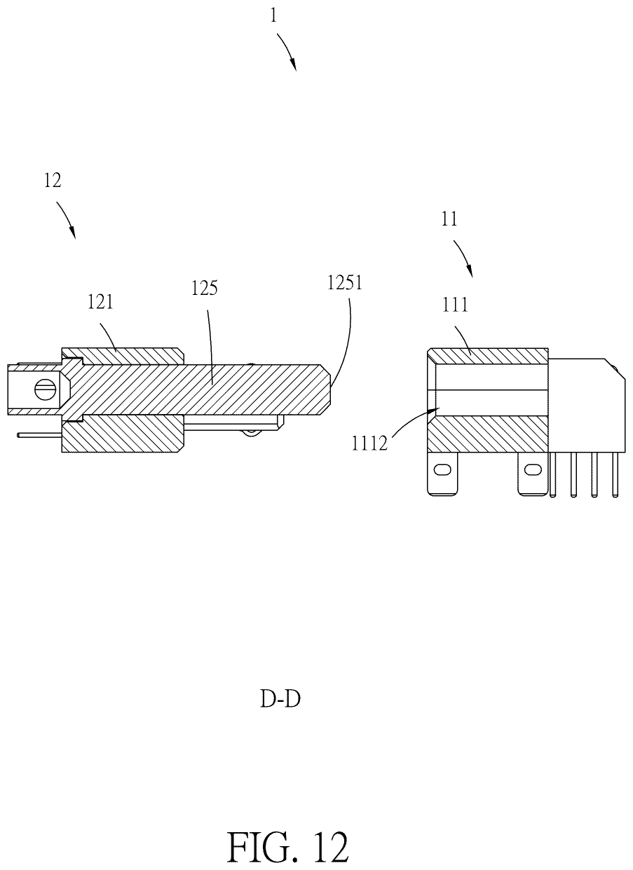

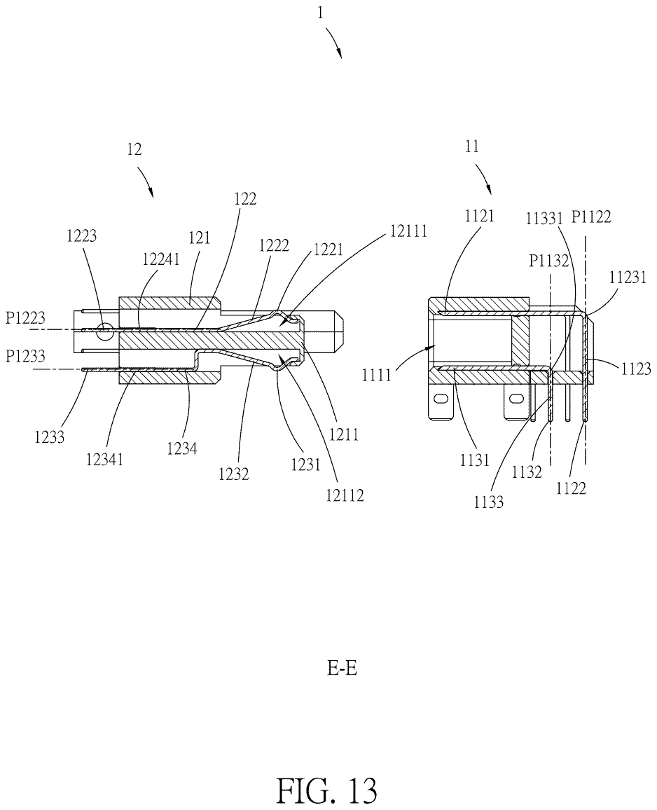

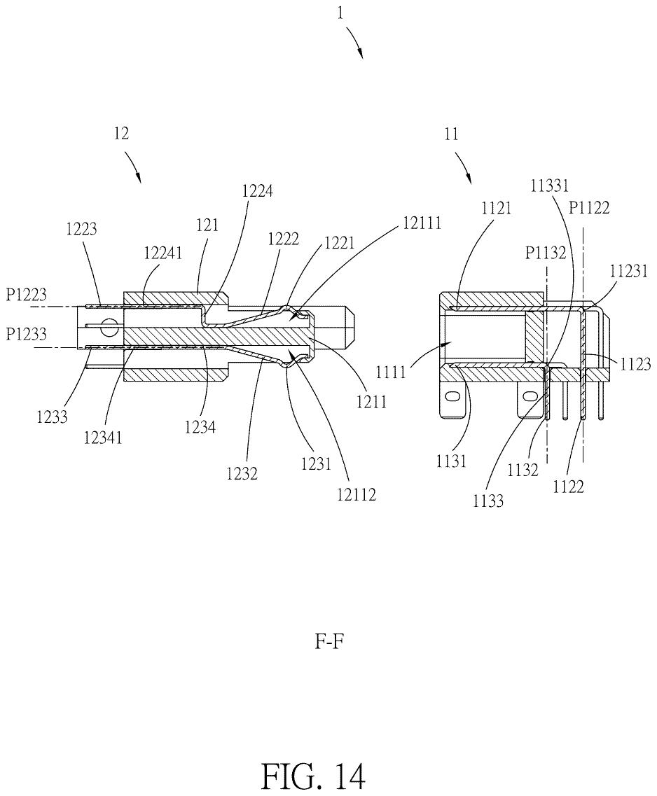

The technical concept of the conductive component assembly and receiving end conductive component and mating end conductive component thereof of the present application should be understood in conjunction with the embodiments illustrated in FIGS. 1 to 14.

In the embodiments shown in FIGS. 1 to 14, at least one conductive component assembly 1 is provided, wherein the conductive component assembly 1 comprises: at least one receiving end conductive component 11 and at least one mating end conductive component 12.

Regarding the receiving end conductive component 11, the receiving end conductive component 11 comprises at least one receiving end conductive component insulation core 111, at least one receiving end conductive component upper terminal 112, at least one receiving end conductive component lower terminal 113, and at least one receiving end conductive component plate 114. The receiving end conductive component insulation core 111 comprises at least one receiving end conductive component insulation core mating recess 1111. The receiving end conductive component upper terminal 112 is configured to transmit signals and comprises at least one receiving end conductive component upper terminal mating structure 1121, at least one receiving end conductive component upper terminal joining structure 1122, and at least one receiving end conductive component upper terminal connecting structure 1123. The receiving end conductive component lower terminal 113 is configured to transmit signals and comprises at least one receiving end conductive component lower terminal mating structure 1131, at least one receiving end conductive component lower terminal joining structure 1132, and at least one receiving end conductive component lower terminal connecting structure 1133.

In the above embodiments, the receiving end conductive component insulation core 111 is configured to respectively mate with the receiving end conductive component upper terminal 112 and the receiving end conductive component lower terminal 113, so as to respectively position the receiving end conductive component upper terminal 112 and the receiving end conductive component lower terminal 113, such that the receiving end conductive component upper terminal mating structure 1121 abuts an upper recess wall of the receiving end conductive component insulation core mating recess 1111, and the receiving end conductive component lower terminal mating structure 1131 abuts a lower recess wall of the receiving end conductive component insulation core mating recess 1111. In this case, the upper recess wall of the receiving end conductive component insulation core mating recess 1111 can support the receiving end conductive component upper terminal mating structure 1121, and the lower recess wall of the receiving end conductive component insulation core mating recess 1111 can support the receiving end conductive component lower terminal mating structure 1131.

In the above embodiments, the receiving end conductive component upper terminal connecting structure 1123 connects the receiving end conductive component upper terminal mating structure 1121 and the receiving end conductive component upper terminal joining structure 1122, such that the receiving end conductive component upper terminal mating structure 1121 and the receiving end conductive component upper terminal joining structure 1122 are integrally connected. The receiving end conductive component upper terminal connecting structure 1123 comprises at least one receiving end conductive component upper terminal connecting structure bent extension section 11231, which provides a bent extension, such that the receiving end conductive component upper terminal joining structure 1122 extends along a receiving end conductive component upper terminal joining path P1122, thereby allowing the receiving end conductive component upper terminal joining structure 1122 to join with the receiving end conductive component plate 114 and transmit signals.

In the above embodiments, the receiving end conductive component lower terminal connecting structure 1133 connects the receiving end conductive component lower terminal mating structure 1131 and the receiving end conductive component lower terminal joining structure 1132, such that the receiving end conductive component lower terminal mating structure 1131 and the receiving end conductive component lower terminal joining structure 1132 are integrally connected. The receiving end conductive component lower terminal connecting structure 1133 comprises a receiving end conductive component lower terminal connecting structure bent extension section 11331, which provides a bent extension, such that the receiving end conductive component lower terminal joining structure 1132 extends along a receiving end conductive component lower terminal joining path P1132, thereby allowing the receiving end conductive component lower terminal joining structure 1132 to join with the receiving end conductive component plate 114 and transmit signals.

Additionally, it should be noted that in the above embodiments, the receiving end conductive component upper terminal joining path P1122 and the receiving end conductive component lower terminal joining path P1132 extend substantially in parallel, which effectively reduces the size of the receiving end conductive component 11, thereby adapting to the internal space of electronic devices.

In the above embodiments, the mating end conductive component 12 is configured to mate with the receiving end conductive component 11 to transmit signals within an electronic device. Regarding the mating end conductive component 12, the mating end conductive component 12 comprises at least one mating end conductive component insulation core 121, at least one mating end conductive component upper terminal 122, at least one mating end conductive component lower terminal 123, and at least one mating end conductive component plate 124. The mating end conductive component insulation core 121 comprises at least one mating end conductive component insulation core mating head 1211. The mating end conductive component upper terminal 122 is configured to transmit signals and comprises at least one mating end conductive component upper terminal mating structure 1221, at least one mating end conductive component upper terminal elastic structure 1222, at least one mating end conductive component upper terminal joining structure 1223, and at least one mating end conductive component upper terminal connecting structure 1224. The mating end conductive component lower terminal 123 is configured to transmit signals and comprises at least one mating end conductive component lower terminal mating structure 1231, at least one mating end conductive component lower terminal elastic structure 1232, at least one mating end conductive component lower terminal joining structure 1233, and at least one mating end conductive component lower terminal connecting structure 1234.

In the above embodiments, the mating end conductive component insulation core 121 is configured to mate with the mating end conductive component upper terminal 122 and the mating end conductive component lower terminal 123, so as to respectively position the mating end conductive component upper terminal 122 and the mating end conductive component lower terminal 123, such that the mating end conductive component upper terminal mating structure 1221 is located above the mating end conductive component insulation core mating head 1211, and the mating end conductive component lower terminal mating structure 1231 is located below the mating end conductive component insulation core mating head 1211.

It should be noted that, during the mating process of the mating end conductive component 12 with the receiving end conductive component 11, the mating end conductive component insulation core mating head 1211 is configured to align with the receiving end conductive component insulation core mating recess 1111, thereby allowing the mating end conductive component insulation core mating head 1211 to easily enter the receiving end conductive component insulation core mating recess 1111. The mating end conductive component upper terminal elastic structure 1222 is configured to apply an elastic force to the mating end conductive component upper terminal mating structure 1221, so that the mating end conductive component upper terminal mating structure 1221 is enabled to provide mating and abuts the receiving end conductive component upper terminal mating structure 1121, such that the mating end conductive component upper terminal 122 mates with the receiving end conductive component upper terminal 112. The mating end conductive component lower terminal elastic structure 1232 is configured to apply an elastic force to the mating end conductive component lower terminal mating structure 1231, so that the mating end conductive component lower terminal mating structure 1231 is enabled to provide mating and abuts the receiving end conductive component lower terminal mating structure 1131, such that the mating end conductive component lower terminal 123 mates with the receiving end conductive component lower terminal 113. Accordingly, the issue of improper mating of components in a small-sized conductive component assembly can be resolved, allowing the conductive component assembly 1 to avoid misalignment between the mating end conductive component 12 and the receiving end conductive component 11 during use, and by means of the elastic force, ensure that the mating end conductive component 12 and the receiving end conductive component 11 are in a proper mating condition, so that the conductive component assembly 1 can accommodate the reduced size of electronic devices while maintaining the expected electrical characteristics, thereby meeting the specific requirements and development of electronic devices.

In the above embodiments, the mating end conductive component upper terminal elastic structure 1222 is located at the mating end conductive component upper terminal connecting structure 1224, and the mating end conductive component upper terminal connecting structure 1224 connects the mating end conductive component upper terminal mating structure 1221 and the mating end conductive component upper terminal joining structure 1223, such that the mating end conductive component upper terminal mating structure 1221 and the mating end conductive component upper terminal joining structure 1223 are integrally connected. The mating end conductive component upper terminal connecting structure 1224 comprises at least one mating end conductive component upper terminal connecting structure straight extension section 12241, which provides a straight extension such that the mating end conductive component upper terminal joining structure 1223 extends along a mating end conductive component upper terminal joining path P1223, thereby allowing the mating end conductive component upper terminal joining structure 1223 to join with the mating end conductive component plate 124 and transmit signals.

In the above embodiments, the mating end conductive component lower terminal elastic structure 1232 is located at the mating end conductive component lower terminal connecting structure 1234, and the mating end conductive component lower terminal connecting structure 1234 connects the mating end conductive component lower terminal mating structure 1231 and the mating end conductive component lower terminal joining structure 1233, such that the mating end conductive component lower terminal mating structure 1231 and the mating end conductive component lower terminal joining structure 1233 are integrally connected. The mating end conductive component lower terminal connecting structure 1234 comprises a mating end conductive component lower terminal connecting structure straight extension section 12341, which provides a straight extension such that the mating end conductive component lower terminal joining structure 1233 extends along a mating end conductive component lower terminal joining path P1233, thereby allowing the mating end conductive component lower terminal joining structure 1233 to join with the mating end conductive component plate 124 and transmit signals.

Additionally, it should be noted that, in the above embodiments, the mating end conductive component upper terminal joining path P1223 and the mating end conductive component lower terminal joining path P1233 extend substantially in parallel. In this way, the size of the mating end conductive component 12 can be effectively reduced to accommodate the internal space of the electronic device.

Furthermore, it should be noted that, in the above embodiments, the extension of the receiving end conductive component upper terminal joining path P1122 and the extension of the mating end conductive component upper terminal joining path P1223 are substantially orthogonal; and the extension of the receiving end conductive component lower terminal joining path P1132 and the extension of the mating end conductive component lower terminal joining path P1233 are substantially orthogonal. In this way, the size of the conductive component assembly 1 can be effectively reduced to accommodate the internal space of the electronic device.

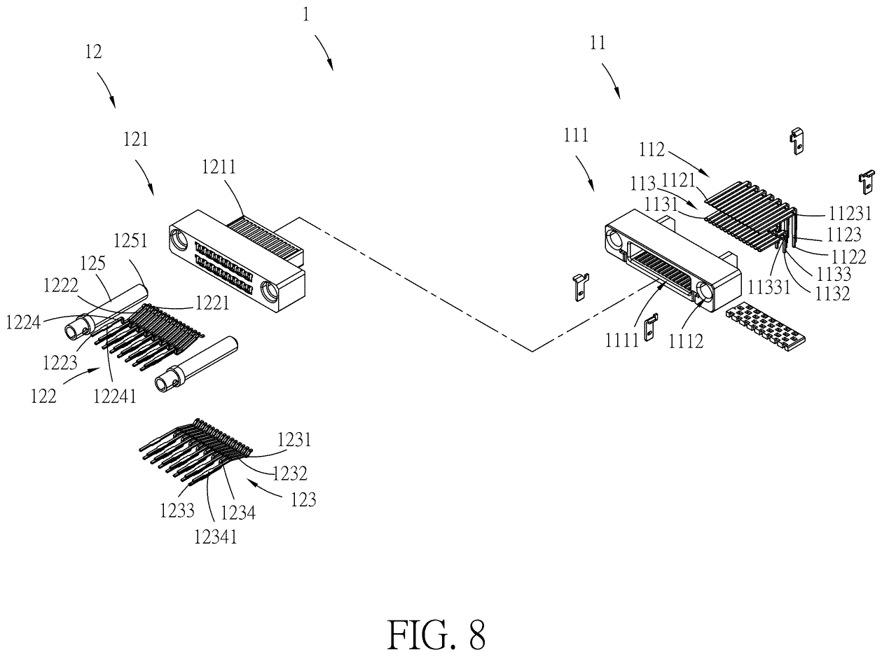

In the embodiments shown in FIGS. 8, 10, and 12, the receiving end conductive component insulation core 111 further comprises at least one receiving end conductive component insulation core guiding hole 1112. Correspondingly, the mating end conductive component 12 further comprises at least one mating guide element 125, and the mating guide element 125 comprises at least one mating guide structure 1251, wherein the mating end conductive component insulation core 121 is configured to mate with the mating guide element 125 such that the mating guide structure 1251 is extended from the mating end conductive component insulation core 121. It should be noted that the mating guide structure 1251 may be, but is not limited to, a columnar structure. During the mating process of the mating end conductive component 12 with the receiving end conductive component 11, the mating guide structure 1251 is configured to enter the receiving end conductive component insulation core guiding hole 1112 to guide the mating of the mating end conductive component insulation core mating head 1211, thereby allowing the mating end conductive component insulation core mating head 1211 to be easily aligned with the receiving end conductive component insulation core mating recess 1111, and guiding the mating end conductive component insulation core mating head 1211 along a predetermined mating path into the receiving end conductive component insulation core mating recess 1111 to achieve the mating of the mating end conductive component 12 with the receiving end conductive component 11. In this way, the issue of improper mating of components in a small-sized conductive component assembly can be resolved, allowing the conductive component assembly 1 to avoid misalignment between the mating end conductive component 12 and the receiving end conductive component 11 during use.

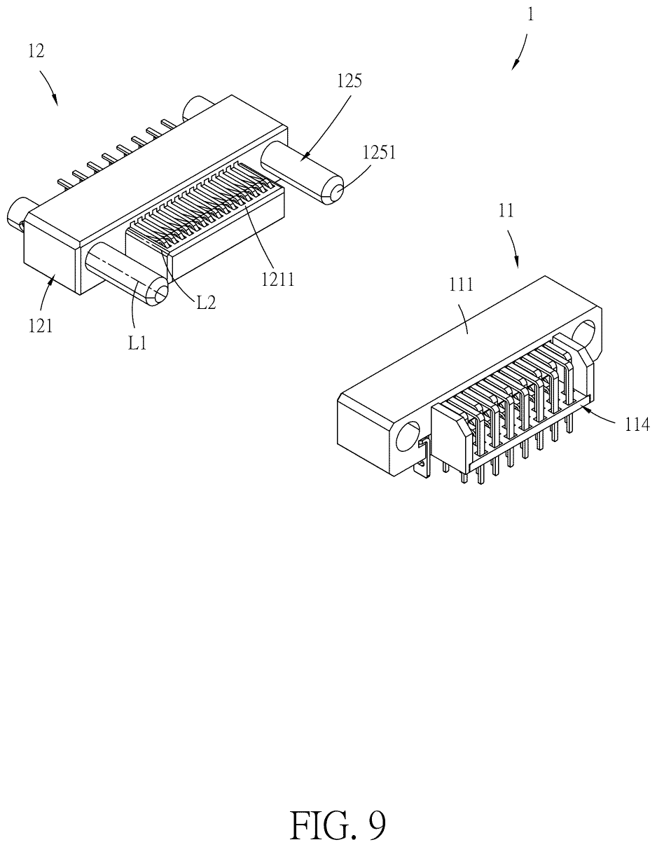

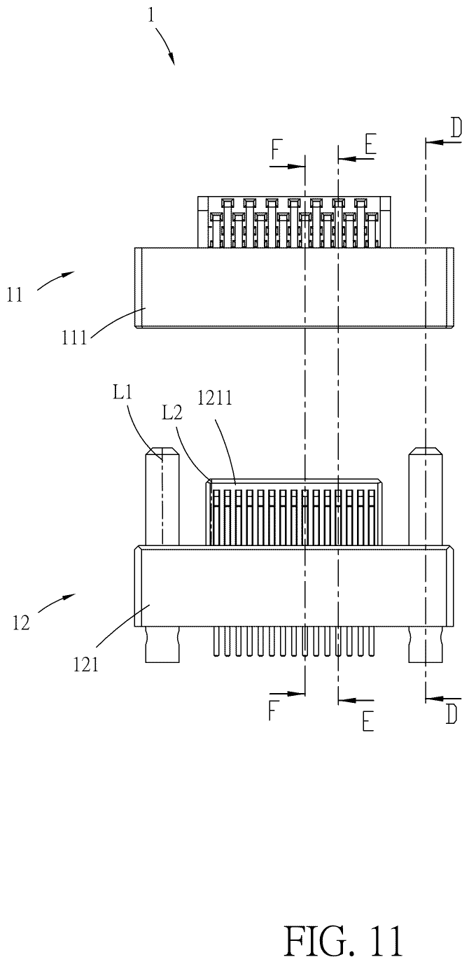

In the embodiments shown in FIGS. 9 and 11, the mating end conductive component insulation core mating head 1211 is extended from the mating end conductive component insulation core 121, and an extension length L1 of the mating guide structure 1251 is greater than an extension length L2 of the mating end conductive component insulation core mating head 1211 from the mating end conductive component insulation core 121, such that when the mating end conductive component 12 is mating with the receiving end conductive component 11, the mating guide structure 1251 is configured to enter the receiving end conductive component insulation core guiding hole 1112 earlier than the mating end conductive component insulation core mating head 1211 enters the receiving end conductive component insulation core mating recess 1111. In this way, it can be ensured that the mating guide structure 1251 guides the mating of the mating end conductive component insulation core mating head 1211.

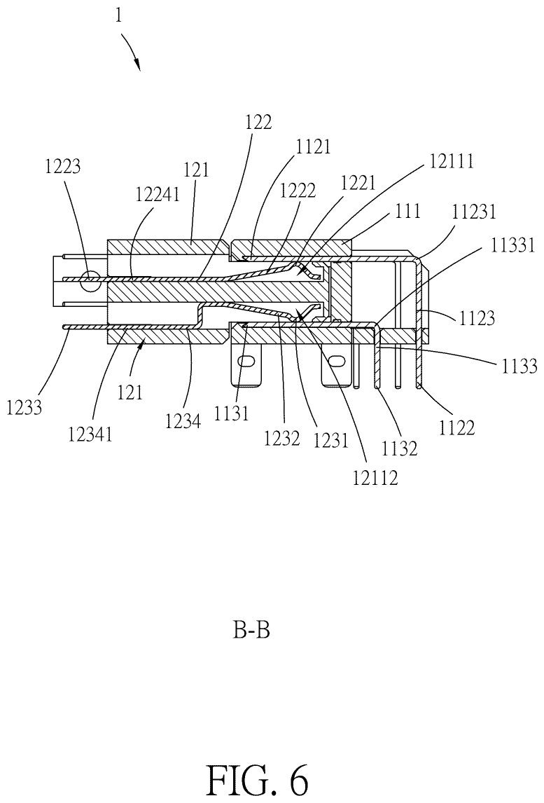

In the embodiments shown in FIGS. 6 to 7 and FIGS. 13 to 14, the mating end conductive component insulation core mating head 1211 comprises a mating end conductive component upper terminal receiving space 12111 and a mating end conductive component lower terminal receiving space 12112. During the mating process of the mating end conductive component 12 with the receiving end conductive component 11, at least a portion of the mating end conductive component upper terminal 122 is configured to be received in the mating end conductive component upper terminal receiving space 12111, and at least a portion of the mating end conductive component lower terminal 123 is configured to be received in the mating end conductive component lower terminal receiving space 12112. In this way, the size of the conductive component assembly 1 can be effectively reduced to accommodate the internal space of the electronic device.

It should be noted that, since the upper recess wall of the receiving end conductive component insulation core mating recess 1111 is configured to support the receiving end conductive component upper terminal mating structure 1121, the receiving end conductive component upper terminal mating structure 1121 is enabled to mate with the mating end conductive component upper terminal 122 and to force the mating end conductive component upper terminal 122 to elastically deform, such that at least a portion of the mating end conductive component upper terminal 122 is configured to be received in the mating end conductive component upper terminal receiving space 12111. Additionally, since the lower recess wall of the receiving end conductive component insulation core mating recess 1111 is configured to support the receiving end conductive component lower terminal mating structure 1131, the receiving end conductive component lower terminal mating structure 1131 is enabled to mate with the mating end conductive component lower terminal 123 and to force the mating end conductive component lower terminal 123 to elastically deform, such that at least a portion of the mating end conductive component lower terminal 123 is configured to be received in the mating end conductive component lower terminal receiving space 12112.

It should be noted that the design of the conductive component assembly and receiving end conductive component and mating end conductive component thereof provided in the present application is not limited to the above descriptions. For example, the conductive component assembly of the present application may optionally comprise: a receiving end conductive component and a mating end conductive component. The receiving end conductive component comprises a receiving end conductive component insulation core, a receiving end conductive component upper terminal, and a receiving end conductive component lower terminal. The receiving end conductive component insulation core comprises a receiving end conductive component insulation core mating recess. The receiving end conductive component upper terminal comprises a receiving end conductive component upper terminal mating structure, and the receiving end conductive component lower terminal comprises a receiving end conductive component lower terminal mating structure, wherein the receiving end conductive component insulation core is configured to mate with the receiving end conductive component upper terminal and the receiving end conductive component lower terminal, such that the receiving end conductive component upper terminal mating structure abuts an upper recess wall of the receiving end conductive component insulation core mating recess, and the receiving end conductive component lower terminal mating structure abuts a lower recess wall of the receiving end conductive component insulation core mating recess. The mating end conductive component is configured to mate with the receiving end conductive component and comprises a mating end conductive component insulation core, a mating end conductive component upper terminal, and a mating end conductive component lower terminal. The mating end conductive component insulation core comprises a mating end conductive component insulation core mating head. The mating end conductive component upper terminal comprises a mating end conductive component upper terminal mating structure and a mating end conductive component upper terminal elastic structure. The mating end conductive component lower terminal comprises a mating end conductive component lower terminal mating structure and a mating end conductive component lower terminal elastic structure, wherein the mating end conductive component insulation core is configured to mate with the mating end conductive component upper terminal and the mating end conductive component lower terminal, such that the mating end conductive component upper terminal mating structure is located above the mating end conductive component insulation core mating head, and the mating end conductive component lower terminal mating structure is located below the mating end conductive component insulation core mating head; wherein, during the mating of the mating end conductive component with the receiving end conductive component, the mating end conductive component insulation core mating head is configured to align with the receiving end conductive component insulation core mating recess, thereby allowing the mating end conductive component insulation core mating head to easily enter the receiving end conductive component insulation core mating recess, such that the mating end conductive component upper terminal elastic structure applies an elastic force to the mating end conductive component upper terminal mating structure, allowing the mating end conductive component upper terminal mating structure to abut the receiving end conductive component upper terminal mating structure, thereby enabling the mating end conductive component upper terminal to mate with the receiving end conductive component upper terminal, and such that the mating end conductive component lower terminal elastic structure applies an elastic force to the mating end conductive component lower terminal mating structure, allowing the mating end conductive component lower terminal mating structure to abut the receiving end conductive component lower terminal mating structure, thereby enabling the mating end conductive component lower terminal to mate with the receiving end conductive component lower terminal.

In addition, the receiving end conductive component of the present application may optionally comprise: a receiving end conductive component insulation core, a receiving end conductive component upper terminal, and a receiving end conductive component lower terminal. The receiving end conductive component insulation core comprises a receiving end conductive component insulation core mating recess. The receiving end conductive component upper terminal comprises a receiving end conductive component upper terminal mating structure. The receiving end conductive component lower terminal comprises a receiving end conductive component lower terminal mating structure, wherein the receiving end conductive component insulation core is configured to mate with the receiving end conductive component upper terminal and the receiving end conductive component lower terminal, such that the receiving end conductive component upper terminal mating structure abuts an upper recess wall of the receiving end conductive component insulation core mating recess, allowing the upper recess wall of the receiving end conductive component insulation core mating recess to support the receiving end conductive component upper terminal mating structure, thereby enabling the receiving end conductive component upper terminal mating structure to provide mating, and such that the receiving end conductive component lower terminal mating structure abuts a lower recess wall of the receiving end conductive component insulation core mating recess, allowing the lower recess wall of the receiving end conductive component insulation core mating recess to support the receiving end conductive component lower terminal mating structure, thereby enabling the receiving end conductive component lower terminal mating structure to provide mating.

Furthermore, the mating end conductive component of the present application may optionally comprise: a mating end conductive component insulation core, a mating end conductive component upper terminal, and a mating end conductive component lower terminal. The mating end conductive component insulation core comprises a mating end conductive component insulation core mating head. The mating end conductive component upper terminal comprises a mating end conductive component upper terminal mating structure and a mating end conductive component upper terminal elastic structure. The mating end conductive component lower terminal comprises a mating end conductive component lower terminal mating structure and a mating end conductive component lower terminal elastic structure, wherein the mating end conductive component insulation core is configured to mate with the mating end conductive component upper terminal and the mating end conductive component lower terminal, such that the mating end conductive component upper terminal mating structure is located above the mating end conductive component insulation core mating head, and the mating end conductive component lower terminal mating structure is located below the mating end conductive component insulation core mating head; and the mating end conductive component upper terminal elastic structure is configured to apply an elastic force to the mating end conductive component upper terminal mating structure to enable mating; and the mating end conductive component lower terminal elastic structure is configured to apply an elastic force to the mating end conductive component lower terminal mating structure to enable mating.

In summary, the present application provides a conductive component assembly and receiving end conductive component and mating conductive component thereof. The receiving end conductive component comprises a receiving end conductive component insulation core mating recess, and the mating end conductive component comprises a mating end conductive component insulation core mating head. The mating end conductive component insulation core mating head is configured to align with the receiving end conductive component insulation core mating recess, thereby allowing the mating end conductive component insulation core mating head to easily enter the receiving end conductive component insulation core mating recess. The conductive terminals of the mating end conductive component are configured to elastically abut the conductive terminals of the receiving end conductive component. In this way, the issue of improper mating of components in a small-sized conductive component assembly can be resolved, allowing the mating end conductive component and the receiving end conductive component to be in a proper mating condition during use, thereby enabling the conductive component assembly to accommodate the reduced size of electronic devices while maintaining the expected electrical characteristics, and to meet the specific requirements and development of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A conductive component assembly comprising:
a receiving end conductive component comprising a receiving end conductive component insulation core, a receiving end conductive component upper terminal, and a receiving end conductive component lower terminal, wherein the receiving end conductive component insulation core comprises a receiving end conductive component insulation core mating recess, the receiving end conductive component upper terminal comprises a receiving end conductive component upper terminal mating structure, and the receiving end conductive component lower terminal comprises a receiving end conductive component lower terminal mating structure, wherein the receiving end conductive component insulation core is configured to be coupled with the receiving end conductive component upper terminal and the receiving end conductive component lower terminal, such that the receiving end conductive component upper terminal mating structure abuts an upper wall of the receiving end conductive component insulation core mating recess, and the receiving end conductive component lower terminal mating structure abuts a lower wall of the receiving end conductive component insulation core mating recess; and
a mating end conductive component configured to mate with the receiving end conductive component, the mating end conductive component comprising a mating end conductive component insulation core, a mating end conductive component upper terminal, and a mating end conductive component lower terminal, wherein the mating end conductive component insulation core comprises a mating end conductive component insulation core mating head, the mating end conductive component upper terminal comprises a mating end conductive component upper terminal mating structure and a mating end conductive component upper terminal elastic structure, and the mating end conductive component lower terminal comprises a mating end conductive component lower terminal mating structure and a mating end conductive component lower terminal elastic structure, wherein the mating end conductive component insulation core is configured to mate with the mating end conductive component upper terminal and the mating end conductive component lower terminal, such that the mating end conductive component upper terminal mating structure is located above the mating end conductive component insulation core mating head, and the mating end conductive component lower terminal mating structure is located below the mating end conductive component insulation core mating head; wherein,
when the mating end conductive component is mating with the receiving end conductive component, the mating end conductive component insulation core mating head is configured to align with the receiving end conductive component insulation core mating recess to allow the mating end conductive component insulation core mating head to enter the receiving end conductive component insulation core mating recess, wherein the mating end conductive component upper terminal elastic structure is configured to apply an elastic force to the mating end conductive component upper terminal mating structure, such that the mating end conductive component upper terminal mating structure abuts the receiving end conductive component upper terminal mating structure, thereby enabling the mating end conductive component upper terminal to mate with the receiving end conductive component upper terminal, and wherein the mating end conductive component lower terminal elastic structure is configured to apply an elastic force to the mating end conductive component lower terminal mating structure, such that the mating end conductive component lower terminal mating structure abuts the receiving end conductive component lower terminal mating structure, thereby enabling the mating end conductive component lower terminal to mate with the receiving end conductive component lower terminal.

2. The conductive component assembly of claim 1, wherein the receiving end conductive component insulation core further comprises a receiving end conductive component insulation core guiding hole, and the mating end conductive component further comprises a mating guide element, the mating guide element comprising a mating guide structure, wherein the mating end conductive component insulation core is configured to mate with the mating guide element such that the mating guide structure is extended from the mating end conductive component insulation core, and when the mating end conductive component is mating with the receiving end conductive component, the mating guide structure is configured to enter the receiving end conductive component insulation core guiding hole and thereby guide the mating end conductive component insulation core mating head into the receiving end conductive component insulation core mating recess.

3. The conductive component assembly of claim 2, wherein an extension length of the mating guide structure is greater than an extension length of the mating end conductive component insulation core mating head, such that the mating guide structure enters the receiving end conductive component insulation core guiding hole before the mating end conductive component insulation core mating head enters the receiving end conductive component insulation core mating recess.

4. The conductive component assembly of claim 2, wherein the mating guide structure is a columnar structure.

5. The conductive component assembly of claim 1, wherein the receiving end conductive component further comprises a receiving end conductive component plate; the receiving end conductive component upper terminal further comprises a receiving end conductive component upper terminal joining structure and a receiving end conductive component upper terminal connecting structure, wherein the receiving end conductive component upper terminal connecting structure comprises a receiving end conductive component upper terminal connecting structure bent extension section and is configured to connect the receiving end conductive component upper terminal mating structure and the receiving end conductive component upper terminal joining structure via the receiving end conductive component upper terminal connecting structure bent extension section that provides a bent connection, so as to allow the receiving end conductive component upper terminal joining structure to extend along a receiving end conductive component upper terminal joining path to join with the receiving end conductive component plate; and the receiving end conductive component lower terminal further comprises a receiving end conductive component lower terminal joining structure and a receiving end conductive component lower terminal connecting structure, wherein the receiving end conductive component lower terminal connecting structure comprises a receiving end conductive component lower terminal connecting structure bent extension section and is configured to connect the receiving end conductive component lower terminal mating structure and the receiving end conductive component lower terminal joining structure via the receiving end conductive component lower terminal connecting structure bent extension section that provides a bent connection, so as to allow the receiving end conductive component lower terminal joining structure to extend along a receiving end conductive component lower terminal joining path to join with the receiving end conductive component plate, wherein the receiving end conductive component upper terminal joining path and the receiving end conductive component lower terminal joining path extend substantially in parallel.

6. The conductive component assembly of claim 5, wherein the mating end conductive component further comprises a mating end conductive component plate; the mating end conductive component upper terminal further comprises a mating end conductive component upper terminal joining structure and a mating end conductive component upper terminal connecting structure, wherein the mating end conductive component upper terminal connecting structure comprises a mating end conductive component upper terminal connecting structure straight extension section and is configured to connect the mating end conductive component upper terminal mating structure and the mating end conductive component upper terminal joining structure via the mating end conductive component upper terminal connecting structure straight extension section that provides a straight connection, so as to allow the mating end conductive component upper terminal joining structure to extend along a mating end conductive component upper terminal joining path to join with the mating end conductive component plate; and the mating end conductive component lower terminal further comprises a mating end conductive component lower terminal joining structure and a mating end conductive component lower terminal connecting structure, wherein the mating end conductive component lower terminal connecting structure comprises a mating end conductive component lower terminal connecting structure straight extension section and is configured to connect the mating end conductive component lower terminal mating structure and the mating end conductive component lower terminal joining structure via the mating end conductive component lower terminal connecting structure straight extension section that provides a straight connection, so as to allow the mating end conductive component lower terminal joining structure to extend along a mating end conductive component lower terminal joining path to join with the mating end conductive component plate, wherein the mating end conductive component upper terminal joining path and the mating end conductive component lower terminal joining path extend substantially in parallel.

7. The conductive component assembly of claim 6, wherein the receiving end conductive component upper terminal joining path and the mating end conductive component upper terminal joining path extend substantially orthogonally; and the receiving end conductive component lower terminal joining path and the mating end conductive component lower terminal joining path extend substantially orthogonally.

8. The conductive component assembly of claim 6, wherein the mating end conductive component insulation core mating head comprises a mating end conductive component upper terminal receiving space and a mating end conductive component lower terminal receiving space, and when the mating end conductive component is mating with the receiving end conductive component, at least a portion of the mating end conductive component upper terminal is configured to be received in the mating end conductive component upper terminal receiving space, and at least a portion of the mating end conductive component lower terminal is configured to be received in the mating end conductive component lower terminal receiving space.

9. The conductive component assembly of claim 8, wherein an upper recess wall of the receiving end conductive component insulation core mating recess is configured to support the receiving end conductive component upper terminal mating structure, such that the receiving end conductive component upper terminal mating structure is configured to elastically deform the mating end conductive component upper terminal, thereby allowing at least a portion of the mating end conductive component upper terminal to be received in the mating end conductive component upper terminal receiving space; and a lower recess wall of the receiving end conductive component insulation core mating recess is configured to support the receiving end conductive component lower terminal mating structure, such that the receiving end conductive component lower terminal mating structure is configured to elastically deform the mating end conductive component lower terminal, thereby allowing at least a portion of the mating end conductive component lower terminal to be received in the mating end conductive component lower terminal receiving space.

10. A receiving end conductive component comprising:
a receiving end conductive component insulation core comprising a receiving end conductive component insulation core mating recess;
a receiving end conductive component upper terminal comprising a receiving end conductive component upper terminal mating structure; and
a receiving end conductive component lower terminal comprising a receiving end conductive component lower terminal mating structure, wherein the receiving end conductive component insulation core is configured to mate with the receiving end conductive component upper terminal and the receiving end conductive component lower terminal, such that the receiving end conductive component upper terminal mating structure abuts and is supported by an upper recess wall of the receiving end conductive component insulation core mating recessto be configured for mating, and the receiving end conductive component lower terminal mating structure abuts and is supported by a lower recess wall of the receiving end conductive component insulation core mating recessto be configured for mating.

11. A mating end conductive component comprising:
a mating end conductive component insulation core comprising a mating end conductive component insulation core mating head;
a mating end conductive component upper terminal comprising a mating end conductive component upper terminal mating structure and a mating end conductive component upper terminal elastic structure; and
a mating end conductive component lower terminal comprising a mating end conductive component lower terminal mating structure and a mating end conductive component lower terminal elastic structure, wherein
the mating end conductive component insulation core is configured to mate with the mating end conductive component upper terminal and the mating end conductive component lower terminal such that the mating end conductive component upper terminal mating structure is located above the mating end conductive component insulation core mating head, and the mating end conductive component lower terminal mating structure is located below the mating end conductive component insulation core mating head; and
the mating end conductive component upper terminal elastic structure is configured to apply an elastic force to the mating end conductive component upper terminal mating structure to allow the mating end conductive component upper terminal mating structure to be configured for mating; and the mating end conductive component lower terminal elastic structure is configured to apply an elastic force to the mating end conductive component lower terminal mating structure to allow the mating end conductive component lower terminal mating structure to be configured for mating.
